(19) United States
(12) Patent Application Publication
(10) Pub. No.: US 2026/0120244 A1
(43) Pub. Date: Apr. 30, 2026

(54) METHOD FOR PROCESSING AN INFRARED IMAGE BY FUSING A PLURALITY OF INFRARED IMAGE COLORIMETRIC PROCESSING OPERATIONS

(71) Applicant: SAFRAN ELECTRONICS & DEFENSE, Paris (FR)

(72) Inventor: Julie Mano, Moissy-Cramayel (FR)

(73) Assignee: SAFRAN ELECTRONICS & DEFENSE, Paris (FR)

(21) Appl. No.: 19/158,016

(22) PCT Filed: Feb. 21, 2024
(86) PCT No.: PCT/FR2024/050233

§ 371 Date: Aug. 19, 2025

(30) Foreign Application Priority Data
Feb. 23, 2023 (FR) FR2301664

(51) Int. Cl. G06T 5/50; G06T 5/40; G06T 11/10

(52) U.S. Cl. CPC G06T 5/50; G06T 5/40; G06T 11/10; G06T 2207/10024; G06T 2207/10048; G06T 2207/20221; G06T 2210/32

(57) ABSTRACT

This method for processing an infrared image captured by an infrared camera comprises the following steps:
a step of duplicating the infrared image to form a first image and a second image;
a step of applying a local processing operation to the first image;
a step of applying a global processing operation to the second image;
a step of colourising at least one region of the second image, by means of a lookup table correlating greyscale levels and a colour computer coding format; and
a step of fusing the first image with the second image to form a final image.

### TECHNICAL FIELD

The present invention relates to the processing of infrared images captured by a thermal camera.

In particular, the present invention relates to a processing method comprising fusing at least two processing operations of a same infrared image so as to emphasise a plurality of types of information of the scene captured in the form of an infrared image.

In general, the invention applies to any type of image that may provide various types of information depending on the image processing applied.

### PRIOR ART

The existing imaging devices comprise for example a camera comprising a sensor and an optical system, as well as an image processing module making it possible respectively to capture an image of a scene and to process said image by applying a processing function.

In particular, the image processing module comprises for example a module for optimising the histogram of the captured images. The histogram of an image is a representation of the intensity distribution of the pixels of said image. The histogram optimisation module is also called A.H.C for Automatic Histogram Control.

The histogram optimisation module is intended to be able to analyse and optimise the processing of the image captured by the camera, for example by stretching the histogram globally and/or locally. In general, stretching a histogram consists, for example, in better distributing the intensity distribution of the pixels of the image, and more generally in giving another form of distribution of the intensities of the pixels. In particular, stretching the histogram globally is performed by taking into account the value of the intensity of all of the pixels of the image while stretching the histogram locally is performed by taking into account the value of the intensity of pixels on one or more precise regions of the image, for example on regions having a particular spatial frequency. Stretching the histogram of the image locally is for example performed by stretching the histogram for each spatial frequency of the image independently of the others, the superposition of these stretched histograms making it possible to obtain the image processed locally.

One advantage of globally stretching a histogram of an infrared image obtained with an infrared sensor, also called thermal sensor, is to favour the detection by a computer or by an operator of areas of interest in the infrared image, for example regions emitting heat. Indeed, global stretching improves the contrast of the image and makes it possible to better detect areas of interest to the detriment of a loss of detail. This advantage is useful for day and night use in surveillance, defence and machine vision applications.

One advantage of locally stretching a histogram of an infrared image is to favour the identification of details in the scene observed by the infrared camera. However, the amount of detail makes the human eye lose the ability thereof to recognise and detect areas of interest, especially hot spots.

The histogram optimisation module also makes it possible to stretch the histogram of an image in a mixed manner, namely by applying a weighting between global stretching and local stretching.

However, choosing a compromise in a mixed manner between local stretching and global stretching does not make it possible to obtain the best performance in each of the two cases, for both detecting areas of interest (for example hot spots within the image) and finely identifying details of the scene represented in the image.

Imaging devices according to the prior art including thermal cameras also comprise a light processing path in addition to the histogram optimisation module in the image processing module. This processing path makes it possible to stretch the histogram of the image globally, or not to apply a histogram stretching processing operation. In particular, this processing path is usually used to transmit tracking information or to retrieve a stream of unprocessed raw images.

In addition, imaging devices according to the prior art may comprise an image fusion module, making it possible for the imaging devices comprising an infrared sensor and a sensor in the visible wavelengths to combine the thermal and visible information on a same image at the output of the imaging device.

### DISCLOSURE OF THE INVENTION

The present invention therefore aims to overcome the aforementioned drawbacks and provide a method for processing an infrared image forming an image offering the best possible performances both in detection and in identification.

The object of the present invention is a method for processing an infrared image captured by an infrared camera, the method comprising the following steps:
a step of duplicating the infrared image to form a first greyscale image and a second greyscale image;
a step of applying a local processing operation emphasising the details on the first image for each spatial frequency by an image processing module;
a step of applying a global processing operation to the second image by the image processing module emphasising hot spots of interest of the second image;
a step of colourising at least one region of the second image by means of a lookup table correlating greyscale levels and a colour computer coding format;
a step of converting the first image from a greyscale format to a colour computer coding format; and
a step of fusing the first image with the second image by an image fusion module to form a final image comprising for each pixel of the final image a weighted fusion of the equivalent pixels of the first image and the region of the second image respectively.

Thus, using pre-existing modules, especially a pre-existing image processing module, the present invention makes it possible to form an infrared image grouping the information of two different processing operations to the maximum of the capacity thereof and thus make it possible for an operator or a computer to easily detect an area of interest, for example via colorimetric information contained in the final image, while being able to identify the details of the observed scene, for example, via information from the local processing operation applied.

In one implementation, the method further comprises a step of displaying the final image in real time by a display screen.

Advantageously, the step of applying a local processing operation comprises stretching the histogram for each spatial frequency of the first image independently of the other spatial frequencies, and comprises superimposing these stretched histograms so as to obtain the first locally processed image.

Advantageously, the step of applying a global processing operation to the second image comprises stretching the histogram of the second image by taking into account the value of the intensity of all of the pixels of the second image.

In a particular implementation, the method comprises an automatic or manual step of selecting the region of the second image.

Advantageously, the step of selecting the region of the second image comprises a step of automatically detecting the region depending on the temperature and/or the movement and/or the shape of said region.

In particular implementations, the colour computer coding format is an RGB or YCbCr format.

Advantageously, the colourising and/or fusion steps are applied to the entire second image or only to one or more regions of the second image.

In one implementation, the steps of applying a local processing operation on the first image and applying a global processing operation on the second image are carried out simultaneously.

Another object of the present invention is a computer program comprising program code instructions for executing the steps of the method as defined previously, when said program is executed on a computer.

Another object of the present invention is a computer-readable recording medium comprising instructions which, when executed by a computer, lead the latter to implement the steps of the method as defined previously.

The present invention also relates to an imaging device comprising an image processing module configured to implement a method for processing an infrared image captured by an infrared camera, as defined above.

### BRIEF DESCRIPTION OF THE DRAWINGS

Other aims, features and advantages of the invention will become apparent upon reading the following description, given merely as a non-limiting example, and made with reference to the appended drawings, wherein:

FIG. 1 is a schematic view of an imaging device intended to implement the method according to the invention; and

FIG. 2 is a schematic illustration of the various steps of the method for processing infrared images according to the invention.

### DETAILED DISCLOSURE OF AT LEAST ONE EMBODIMENT

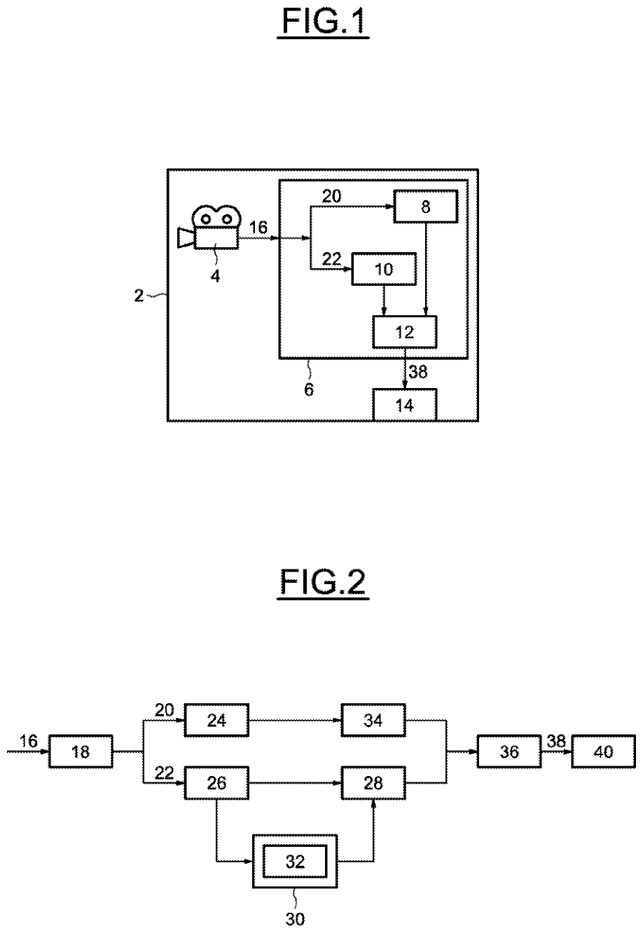

FIG. 1 schematically shows an imaging device 2 intended to implement the method described below.

The imaging device 2 comprises an infrared camera comprising an optical system and an infrared sensor 4 as well as an image processing module 6 that may resemble a computer program embedded in the camera. The image processing module 6 comprises, on the one hand, a module for locally optimising the histogram 8 of images captured by the infrared sensor 4, and, on the other hand, a light module for globally stretching 10 images captured by the infrared sensor 4.

The image processing module 6 also comprises a module 12 for fusing an image output from the histogram local optimisation module 8 with an image output from the light global stretching module 10.

In particular, the histogram local optimisation module 8 makes it possible to stretch the histogram of an image locally. The light global stretching module 10 makes it possible to stretch the histogram of an image globally.

The imaging device 2 optionally comprises a screen 14 for displaying an image. For example, the displayed image is the image obtained as output of the fusion module 12.

FIG. 2 schematically shows the various steps of a method for processing an infrared image 16 captured by an infrared sensor 4 in one implementation. The infrared sensor is for example the infrared sensor 4 of the imaging device 2 illustrated in FIG. 1 and the method is for example implemented by the imaging device 2 illustrated in FIG. 1.

For the implementation of the processing method, first a step 18 of duplicating the infrared image 16 captured by the infrared sensor 4 is carried out. For example, the infrared image 16 is in greyscale.

The duplication thus generates a first image 20 and a second image 22, identical to the captured infrared image 16, and in greyscale. In particular, the infrared image 16 represents an indoor or outdoor scene. The duplication step 18 may be carried out more particularly with a duplication module (not shown) included in the imaging device.

The duplication step 18 may also be carried out by duplicating the infrared image 16 into a number N of images. This makes it possible to subsequently apply a number N of different image processing operations respectively to said N images. Preferably, N is between 2 and 4 duplicate images. The present invention is therefore not limited to duplicating, processing and fusing two processing operations of an image.

A step 24 of applying a local processing operation emphasising the details on the first image 20 is subsequently carried out. The details correspond to the high spatial frequencies of an image. This step 24 is for example implemented with the image processing module 6 by the histogram local optimisation module 8.

In particular, the step 24 of applying a local processing operation comprises for example stretching the histogram for each spatial frequency of the first image independently of the others, and comprises superimposing these stretched histograms so as to obtain the first locally processed image. In other words, the first image is processed by spatial frequency, the local processing operation raises the high spatial frequencies and lowers the low spatial frequencies for different resolutions of the image. This subsequently makes it possible to study the various spatial components of the image. Thus, the intensity value of the pixels for a given spatial frequency is modified and stretched over the entire spectrum of possible intensities. Histogram stretching is performed for each spatial frequency of the first image, and all of the virtual sub-images are combined into a first processed image, a first image having many intensity variations, and therefore a greater number of details, is obtained. In other words, the local processing operation will further highlight the spatial information of the first image by raising the contours at various scales of said first image.

A step 26 of applying a global processing operation to the second image 22 is also carried out. This step 26 is for example implemented with the image processing module 6 and more particularly with the light global stretching module 10. In one implementation, this step 26 comprises stretching the histogram of the second image. In other words, the value of the intensity of all of the pixels of the second image is modified such that the histogram of these values is stretched over all possible pixel intensity values. More specifically, the stretching of the histogram is carried out by applying an intensity gain to each of the pixels so as to fully fill the intensity dynamic of the image, then by carrying out a reset of the histogram around the mean value of said intensity dynamic of the image. Optionally, it is possible to customise this processing operation, for example, by choosing the number of pixels that must be at a saturation value, by increasing or limiting the gain, in other words, the contrast, or by applying an offset to the pixel values of the second image, in other words by increasing or decreasing the brightness. Obviously, the global processing operation does not modify the contrast ratios between the various light intensities of an image, especially in order to maintain a “thermal” view of said image.

Advantageously, the steps 24 and 26 of applying a local processing operation and applying a global processing operation are carried out simultaneously. This is made possible by the fact that the first image 20 and the second image 22 are processed independently, for example respectively by the histogram local optimisation module 8 on the one hand and the light global stretching module 10 on the other hand.

Alternatively, N images are duplicated, for example four images, steps 24 and 26 being applied to two images and different processing steps being applied to the two remaining images to modify them, for example by additional processing bricks.

A step 28 of colourising at least one region of the second processed image 22 is subsequently carried out. This step 28 is carried out by means of a lookup table correlating greyscale levels and a colour computer coding format.

The colour computer coding format is for example an RGB or YCbCr format.

Thus, each greyscale corresponds to a precise colour combination defined in the correlation lookup table. This correlation makes it possible to better highlight areas of interest, especially hot spots in the infrared image. One advantage is that the obtained colorimetric information highlights for the observer the elements of interest in the scene, for example hot spots, while being superimposable with another type of information, such as intensity variations illustrating the details of the image.

The colourising step 28 is applied, for example, to the entire second processed image 22.

Alternatively, before the colourising step 28, a step 30 of automatically or manually selecting one or more regions of said second processed or unprocessed image 22, is carried out. The colourising step may then be applied only to one or the selected regions, the unselected regions still being converted into a computer colour coding format, without however changing the visual rendering thereof. Thus, in an RGB-type colour computer coding format, namely with three red, green and blue components, unselected regions retain a greyscale appearance while having the RGB components thereof such that the intensity of the red component is equal, for each pixel of an unselected region, to the intensity of the green component, as well as to the intensity of the blue component, noted R=G=B.

The selection is for example manual and is carried out by an operator who selects, for example on a display screen, the areas of interest of the second image 20.

Optionally, the step of selecting a region of the second image 22 comprises a step 32 of automatically detecting the region depending on the temperature and/or the movement and/or the shape of said region. Detection is carried out automatically by a computer and/or an embedded electronic board depending on criteria of temperature, and/or of movement and/or of shape of the region to be selected.

Thus, the detection of a hot spot of interest subsequently makes it possible to colourise it in order to make it more visible.

At the same time, a step 34 is carried out of converting the first image 20 from the greyscale format thereof to a colour computer coding format. This step 34 is similar to the conversion of the unselected regions mentioned above. In anticipation of the fusion of the first and second images 20 and 22, the first image 20 is converted into a colour computer coding format while retaining the same greyscale visual appearance. Thus, in an RGB-type colour computer coding format, the intensity of the red component is equal, for each pixel of the first image, to the intensity of the green component, as well as to the intensity of the blue component, noted R=G=B.

A step 36 is subsequently carried out of fusing the first image 20 modified after the step 34 with the second image 22 modified after the step 28 to form a final image 38, the first and the second image being in the same colour computer coding format. If applicable, the fusion step 36 makes it possible to fuse the N modified images. The fusion step 36 is for example carried out by the module 12 for fusing images of the imaging device 2.

The final image 38 more particularly comprises for each pixel of said final image 38 a weighted fusion of the equivalent pixels of the first image 20 and the second image 22 respectively. Equivalent pixels means the pixels of the first and second images that correspond to the same pixel in the captured infrared image.

According to one example of weighted fusion, by noting x and y the coordinates of each pixel of the final image 38, a the weighting factor between 0 and 1, R, G, B the colour intensities for an RGB colour computer coding format, the RGB intensities are obtained for each pixel of the final image 38, such as:

$$\{ \begin{matrix}R ( x , y ) = α * {R}_{im 1} ( x , y ) + ( 1 - α ) * {R}_{im 2} ( x , y ) \\ G ( x , y ) = α * {G}_{im 1} ( x , y ) + ( 1 - α ) * {G}_{im 2} ( x , y ) \\ B ( x , y ) = α * {B}_{im 1} ( x , y ) + ( 1 - α ) * {B}_{im 2} ( x , y )\end{matrix}$$

The weighting factor may be modified by an operator. When it is equal to 0, only the modified second image 22 is visible on the final image 38. When it is equal to 1, only the first modified image 20 is visible on the final image 38.

Optionally, the weighting factor is different according to the x and y coordinates, for example for coordinates within selected regions.

The step 36 of fusing the first modified image 20 with the second modified image 22 to form a final image 38 makes it possible to combine the respective interests of a local processing operation and of a global processing operation, and therefore to facilitate identification and detection on the same final image 38 respectively.

Optionally, a step 40 of displaying the final image 38 is carried out by the display screen 14 of the imaging device 2, the display step 40 preferably being carried out in real time so that the display step 40 is carried out at most one second after the infrared image 16 has been duplicated, for example in a time corresponding to three processing frames, i.e. 60 milliseconds for an acquisition frequency of 50 Hz.

1. Method for processing an infrared image captured by an infrared camera, the method comprising the following steps:
a step of duplicating the infrared image to form a first greyscale image and a second greyscale image;
a step of applying a local processing operation emphasising the details on the first image for each spatial frequency by an image processing module;
a step of applying a global processing operation to the second image by the image processing module emphasising hot spots of interest of the second image;
a step of colourising at least one region of the second image by means of a lookup table correlating greyscale levels and a colour computer coding format;
a step of converting the first image from a greyscale format to a colour computer coding format; and
a step of fusing the first image with the second image by an image fusion module, the resulting fusion to form a final image comprising for each pixel of the final image a weighted fusion of the equivalent pixels of the first image and the region of the second image respectively.

2. Method according to claim 1, further comprising a step of displaying the final image in real time by a display screen.

3. Method according to claim 1, wherein the step of applying a local processing operation comprises stretching the histogram for each spatial frequency of the first image independently of the other spatial frequencies, and comprises superimposing these stretched histograms so as to obtain the first locally processed image.

4. Method according to claim 1, wherein the step of applying a global processing operation to the second image comprises stretching the histogram of the second image by taking into account the value of the intensity of all of the pixels of the second image.

5. Method according to claim 1, comprising an automatic or manual step of selecting the region of the second image.

6. Method according to claim 5, wherein the step of selecting the region of the second image comprises a step of automatically detecting the region depending on the temperature and/or the movement and/or the shape of said region.

7. Method according to claim 1, wherein the colour computer coding format is an RGB or YCbCr format.

8. Method according to claim 1, wherein the colourising and/or fusion steps are applied to the entire second image or only to one or more regions of the second image.

9. Method according to claim 1, wherein the steps of applying a local processing operation to the first image and applying a global processing operation to the second image are carried out simultaneously.

10. Computer program comprising program code instructions for executing the steps of the method according to claim 1, when said program is executed on a computer.
